(19) United States
(12) Patent Application Publication
(10) Pub. No.: US 2009/0310834 A1
(43) Pub. Date: Dec. 17, 2009

(54) PORTAL/NON-PORTAL IMAGE REGISTRATION SYSTEM

(75) Inventor: Ching-Fen JIANG, Dashu Township (TW)

Correspondence Address: FOLEY AND LARDNER LLP;SUITE 500, 3000 K STREET NW, WASHINGTON, DC, 20007, US

(73) Assignee: I SHOU UNIVERSITY

(21) Appl. No.: 12/359,546

(22) Filed: Jan. 26, 2009

(30) Foreign Application Priority Data
Jun. 12, 2008 (TW) 097121898

(51) Int. Cl. G06K 9/00; G06K 9/40

(52) U.S. Cl. 382/128; 382/266; 382/275

(57) ABSTRACT

A portal/non-portal image registration system for registering portal and non-portal images includes a user interface, an image preprocessing unit, a contour detecting unit, and an image registration unit. The user interface is operable for selecting points on portal and non-portal images. The image preprocessing unit is operable, with reference to the selected points, so as to adjust orientations and scales of the portal and non-portal images to obtain preprocessed portal and non-portal images. The contour detecting unit is operable so as to reconstruct contours of the preprocessed portal and non-portal images to obtain reconstructed portal and non-portal contours. The image registration unit includes a registering module operable so as to conduct image registration based upon feature information of the reconstructed portal and non-portal contours using Generalized Hough Transform.

### BACKGROUND OF THE INVENTION

1. Field of the Invention

The present invention relates to image processing technology, more particularly to a portal/non-portal image registration system for radiation treatment planning.

2. Description of the Related Art

Patient positioning errors can result from two sources: system error and random error. The former is due to inaccuracies in system position setup, and the latter is caused by inconsistencies in patient position due to movement of the patient, such as breathing, during image acquisition.

In radiation treatment planning, a patient is required to be immobilized on a patient support system for taking an X-ray projection image, called simulation image, using a simulator. A portal image is taken subsequently for the patient using a linear accelerator to reveal a beam portal shape. In such a radiation treatment planning, a radiotherapist usually needs to compare anatomic features in the simulation and portal images to determine the correspondence thereof and to measure the system error. If the system error is outside an acceptable range, the system setup of the linear accelerator should be readjusted.

It is noted that, in the process of the radiation treatment planning, the patient positioning errors are usually measured by visual inspection, which is labor intensive. In addition, blurring characteristics in the portal image increase the difficulty when registering the portal image with the simulation image by human observation.

### SUMMARY OF THE INVENTION

Therefore, an object of the present invention is to provide a portal/non-portal image registration system for registering portal and non-portal images that can overcome the above drawbacks of the prior art.

Accordingly, a portal/non-portal image registration system for registering portal and non-portal images of this invention comprises a user interface, an image preprocessing unit, a contour detecting unit, and an image registration unit.

The user interface is operable for selecting a pair of points on the non-portal image and a pair of corresponding points on the portal image. The image preprocessing unit is operable, with reference to the points selected for the portal and non-portal images through the user interface, so as to adjust orientations of the portal and non-portal images to minimize an orientation difference therebetween, and to adjust scales of the portal and non-portal images to minimize a scale difference therebetween, thereby obtaining preprocessed portal and non-portal images. The contour detecting unit is operable so as to reconstruct contours of the preprocessed portal and non-portal images from the image preprocessing unit to thereby obtain reconstructed portal and non-portal contours. The image registration unit includes a registering module operable so as to conduct image registration based upon feature information of the reconstructed portal and non-portal contours using Generalized Hough Transform to thereby obtain a registered image output.

Another object of the present invention is to provide a computer-implemented portal/non-portal image registration method for registering portal and non-portal images capable of overcoming the above drawbacks of the prior art.

Accordingly, a portal/non-portal image registration method for registering portal and non-portal images of this invention comprises the following computer-implemented steps:

a) enabling selection of a pair of points on the non-portal image and a pair of corresponding points on the portal image through a user interface;

b) performing image preprocessing with reference to the points selected for the portal and non-portal images so as to obtain preprocessed portal and non-portal images, the image preprocessing including adjusting orientations of the portal and non-portal images to minimize an orientation difference therebetween, and adjusting scales of the portal and non-portal images to minimize a scale difference therebetween;

c) reconstructing contours of the preprocessed portal and non-portal images to obtain reconstructed portal and non-portal contours; and

d) performing image registration based upon feature information of the reconstructed portal and non-portal contours using Generalized Hough Transform, thereby obtaining a registered image output.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a preferred embodiment of a portal/non-portal image registration system of the present invention;

FIG. 2 is a flow chart illustrating a preferred embodiment of a portal/non-portal image registration method of the present invention;

FIG. 3 is a schematic diagram illustrating exemplary simulation and portal images, and two sets of points selected for the simulation and portal images for adjusting orientations and scales of the simulation and portal images;

FIG. 4 is a schematic diagram illustrating division of preprocessed simulation and portal images by a set of lines that intersect orthogonally and that are evenly distributed;

FIG. 5 is a schematic diagram illustrating an initial contour, sample points on the initial contour, and a reconstructed contour; and

FIG. 6 is a schematic diagram illustrating a first reference point for a reconstructed simulation contour and a second reference point for a reconstructed portal contour useful during image registration and fusion.

### DETAILED DESCRIPTION OF THE PREFERRED EMBODIMENT

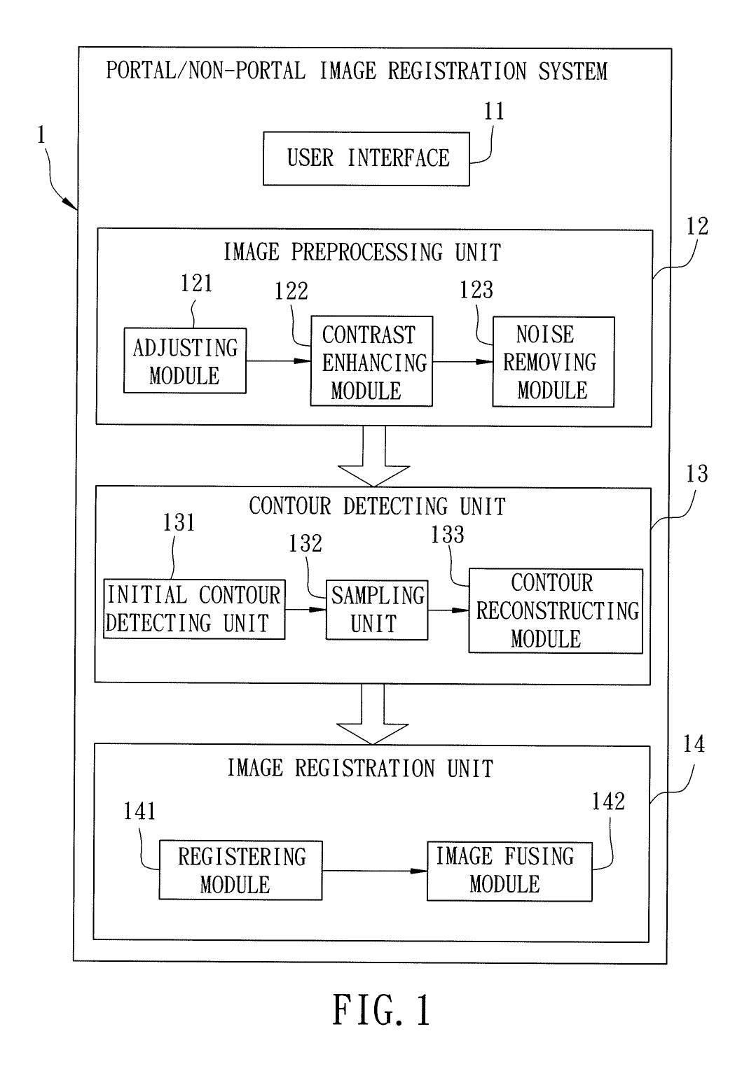

Referring to FIG. 1, the preferred embodiment of a portal/non-portal image registration system 1 of the present invention includes a user interface 11, an image preprocessing unit 12, a contour detecting unit 13, and an image registration unit 14. In practice, the portal/non-portal image registration system 1 may be a computer loaded with proprietary software such that the computer is able to perform functions associated with the user interface 11, the image preprocessing unit 12, the contour detecting unit 13, and the image registration unit 14.

The user interface 11 is operable for selecting a pair of points on each of portal and non-portal images, which will be described in greater detail in the succeeding paragraphs. The non-portal image can be, but is not limited to, a simulation image taken by a simulator or a digitally reconstructed radiograph, and is exemplified as the simulation image in this embodiment. Preferably, the user interface 11 is further operable for selecting a region of interest (ROI) from each of the simulation and portal images.

The image preprocessing unit 12 includes an adjusting module 121, a contrast enhancing module 122, and a noise removing module 123. The adjusting module 121 is operable, with reference to the points selected for the simulation and portal images through the user interface 11, so as to adjust orientations of the simulation and portal images to minimize an orientation difference therebetween, and to adjust scales of the simulation and portal images to minimize a scale difference therebetween. After selecting the ROI from each of the simulation and portal images through the user interface 11, the contrast enhancing module 122 is operable so as to perform contrast enhancement upon the ROIs of the simulation and portal images, followed by a noise-removal processing performed by the noise removing module 123 to thereby obtain preprocessed simulation and portal images. In practice, the contrast enhancing module 122 may be a Gamma Filter, and the noise removing module 123 may be a 5×5 Average Filter.

The contour detecting unit 13 includes an initial contour detecting module having an initial contour detecting unit 131 and a sampling module 132, and a contour reconstructing module 133. The initial contour detecting unit 131 is operable so as to determine an optimal set of threshold values for each of the preprocessed simulation and portal images to thereby detect an initial contour for each of the preprocessed simulation and portal images using a modified Otsu's Method. The sampling unit 132 is operable so as to obtain sample points on each of the initial contours for the preprocessed simulation and portal images. Subsequently, the contour reconstructing module 133 is operable so as to obtain reconstructed simulation and portal contours from the sample points obtained by the sampling unit 132 using a cubic spline function. Preferably, the user interface 11 is further operable so as to remove unwanted portions or to select desired portions of the initial contours for the preprocessed simulation and portal images prior to sampling of the initial contours by the sampling unit 132.

The image registration unit 14 includes a registering module 141 for conducting image registration based upon feature information of the reconstructed simulation and portal contours using Generalized Hough Transform to thereby obtain a registered image output, and an image fusing module 142 for fusing the registered image output.

Preferably, the user interface 11 is operable to select isocenters for both of the reconstructed simulation and portal contours after fusing the registered image output. According to the isocenters, the portal/non-portal image registration system 1 is operable to calculate a position error of the isocenters, and to provide information about the position error to a radiotherapist.

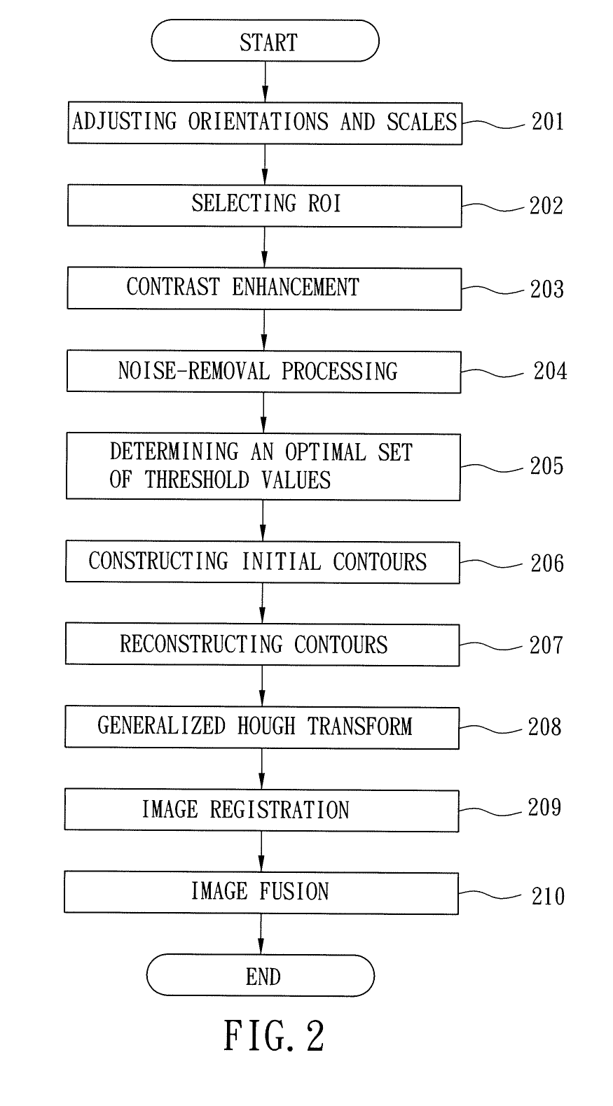

Referring to FIGS. 1 and 2, the preferred embodiment of a portal/non-portal image registration method implemented using the image registration system 1 includes the following computer-implemented steps.

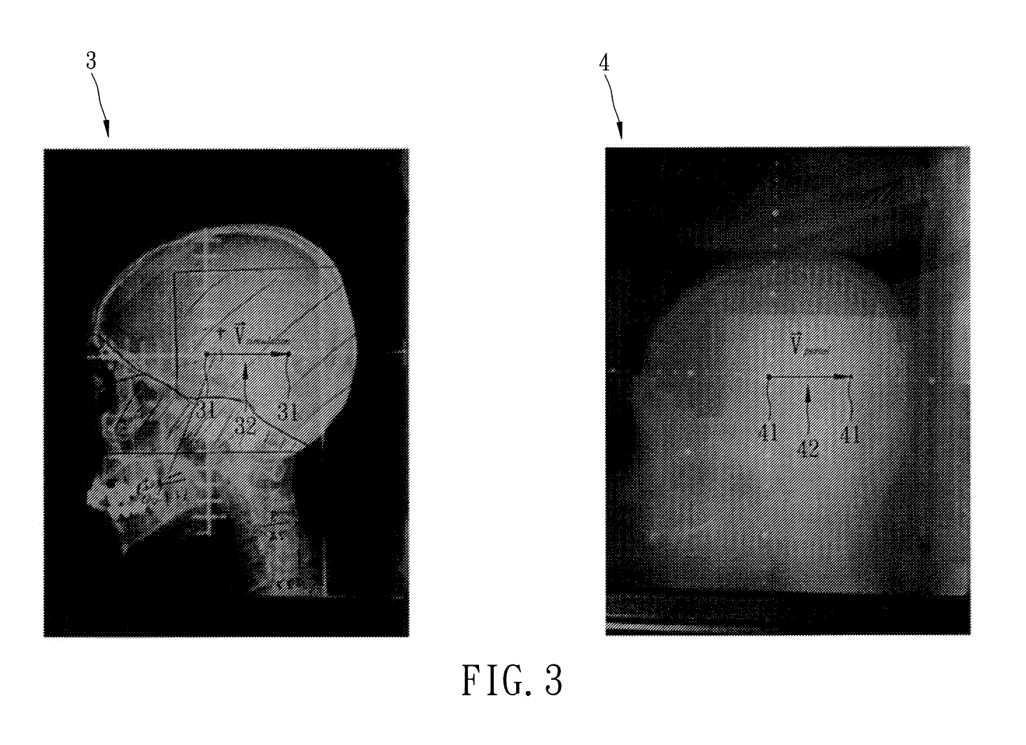

Further referring to FIG. 3, step 201 is to select a pair of points 31 on the simulation image 3 (the non-portal image) and a pair of corresponding points 41 on the portal image 4 through the user interface 11 of the portal/non-portal image registration system 1, and to adjust the orientations and scales of the simulation and portal images 3, 4 to minimize the orientation difference and the scale difference therebetween via the adjusting module 121 of the image preprocessing unit 12. The points 31 and the corresponding points 41 are on horizontal X-axes 32, 42 of the cross scales on the simulation and portal images 3 and 4, and form vectors \vec{V}ₛᵢₘᵤₗₐₜᵢₒₙ and \vec{V}ₚₒᵣₜₐₗ, respectively. Moreover, a number of graduations between the points 31 is equal to that between the corresponding points 41. The adjusting module 121 is operable so as to adjust the orientations of the simulation and portal images 3, 4 based upon the following equations (1) and (2):

$$\begin{matrix}θ = {cos}^{- 1} \frac{{\vec{V}}_{simulation} \cdot {\vec{V}}_{portal}}{( \vert {\vec{V}}_{simulation} \vert \vert {\vec{V}}_{portal} \vert )} , and & ( 1 ) \\ [ \begin{matrix}{x}^{′} \\ {y}^{′}\end{matrix} ] = [ \begin{matrix}cos θ & sin θ \\ sin θ & cos θ\end{matrix} ] [ \begin{matrix}x \\ y\end{matrix} ] , & ( 2 )\end{matrix}$$

wherein the portal image 4 is rotated at an angle (−θ), and (x, y) represents coordinates of the original image point to be rotated into new coordinates (x′, y′).

After adjusting orientations of the simulation and portal images 3 and 4, scale adjustment is further performed using the adjusting module 121 to minimize the scale difference between the simulation and portal images 3 and 4, i.e., the simulation and portal images 3 and 4 have approximately the same scale, i.e., |\vec{V}ₛᵢₘᵤₗₐₜᵢₒₙ|=|\vec{V}ₚₒᵣₜₐₗ|, after scale adjustment.

In step 202, the ROI is selected from each of the simulation and portal images 3, 4 through the user interface 11 of the portal/non-portal image registration system 1. Step 203 involves contrast enhancement upon the ROIs of the simulation and portal images 3, 4 performed by the contrast enhancing module 122 of the image preprocessing unit 12. Subsequently, in step 204, noise-removal processing is performed by the noise removing module 123 of the image preprocessing unit 12, to obtain the preprocessed simulation and portal images. Since contrast enhancement and noise-removal processing are known in the art, further details of the same will be omitted herein for the sake of brevity.

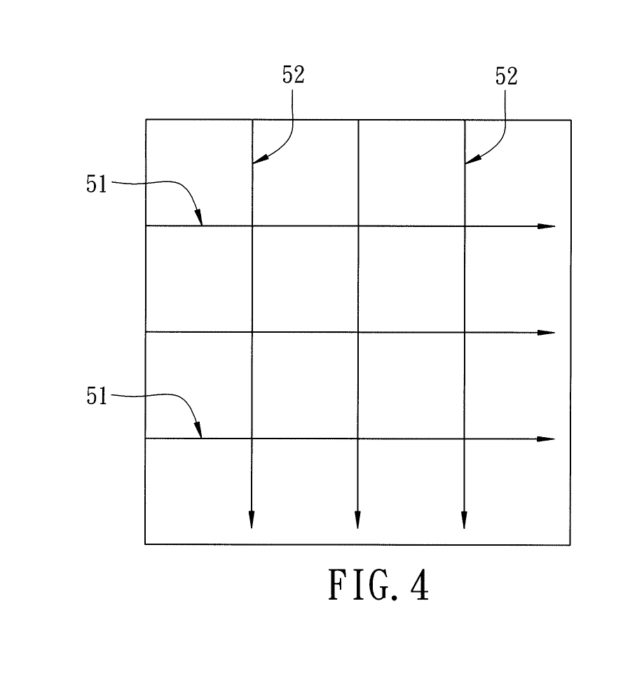

Step 205 is to determine an optimal set of threshold values using the initial contour detecting unit 131. First, each of the preprocessed simulation and portal images is divided using a set of orthogonally intersecting horizontal lines 51 and vertical lines 52 that are evenly distributed as shown in FIG. 4, and pixel values on the horizontal and vertical lines 51, 52 are replaced by mean values of neighboring pixels calculated based upon the following equation,

$$\overline{I} ( x , y ) = \frac{1}{9} {\sum }_{i = - 1}^{1} {\sum }_{j = - 1}^{1} I ( x + i , y + j ) , \qquad ( 3 )$$

wherein (x,y) are pixel coordinates, and I is the pixel value on the lines 51, 52.

Second, a gradient of each pixel on the lines 51, 52 is calculated based upon the mean values Ī(x,y) using the following equation set,

∇g(x,y)=Ī(x,y+1)−Ī(x,y) for vertical lines, and (4)

∇g(x,y)=Ī(x+1,y)−Ī(x,y) for horizontal lines. (5)

Subsequently, the optimal set of the threshold values for each of the preprocessed simulation and portal images is determined based upon the equation,

{k₁*,k₂*}∈{Īₘ|Īₘ=median[Ī(x,y),Ī(∇gₜ(x,y))]}, (6)

wherein ∇gₜ(x,y) is the t^{th} one of the five highest ∇g(x,y) of each line, and Īₘ is a median pixel value from the five highest ∇g(x,y) and the mean value Ī(x,y) of each line.

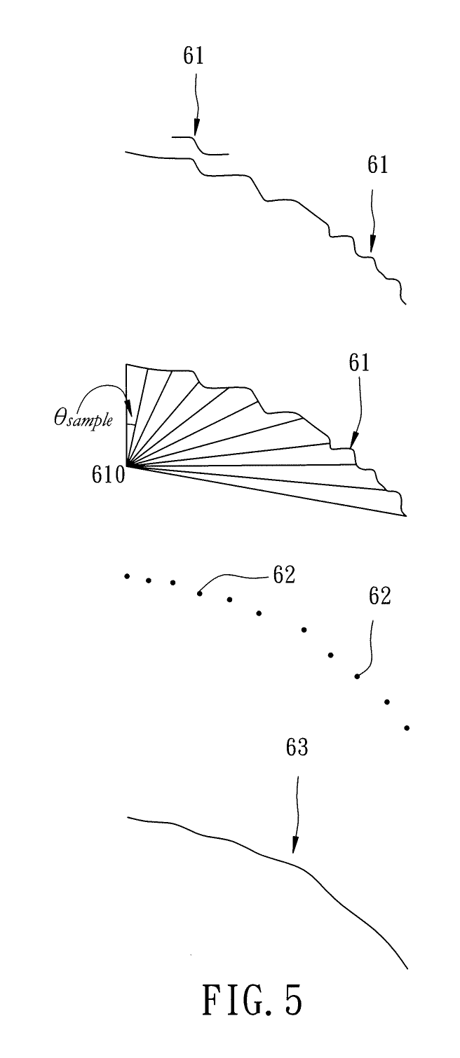

Next, step 206 is to construct an initial contour 61 (see FIG. 5) for each of the preprocessed simulation and portal images through the initial contour detecting unit 131 using the modified Otsu's Method with reference to the optimal set of threshold values {k₁*,k₂*} obtained in step 205. Moreover, the initial contours 61 correspond respectively to the ROIs of the simulation and portal images 3, 4. Preferably, unwanted portions of each of the initial contours 61 are removed through the user interface 11 of the portal/non-portal image registration system 1. Alternatively, desired portions of the initial contours 61 are selected through the user interface 11 of the portal/non-portal image registration system 1. Further, a centroid 610 shown in FIG. 5 is calculated for each of the initial contours 61 to thereby obtain a set of sample points 62 at intersections of one of the initial contours 61 with radial lines that radiate from the centroid 610 and that are equiangularly spaced apart at an angle θₛₐₘₚₗₑ.

Step 207 is to reconstruct contours of the preprocessed simulation and portal images using the contour reconstructing module 133 of the contour detecting unit 13 to obtain reconstructed simulation and portal contours 63 shown in FIG. 5. The reconstructed simulation and portal contours 63 are obtained using a cubic spline function with reference to the sample points 62 obtained in step 206.

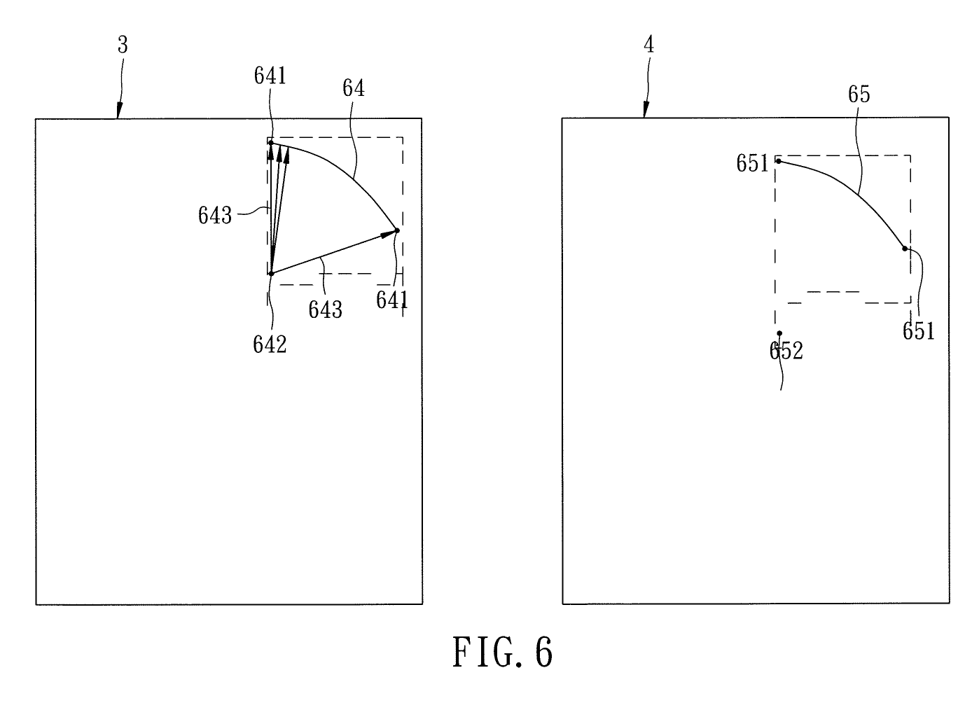

Further referring to FIG. 6, step 208 is to define a first reference point 642 for the reconstructed simulation contour 64 and to obtain a second reference point 652 for the reconstructed portal contour 65 using Generalized Hough Transform (GHT). Since the reconstructed simulation contour 64 is more complete than the reconstructed portal contour 65, the reconstructed simulation contour 64 is used as a source contour to construct an R-table for GHT. First, the first reference point 642 is determined arbitrarily for the reconstructed simulation contour 64 through the user interface 11. In practice, the first reference point 642 can be the centroid of the reconstructed simulation contour 64. A set of vectors 643 is defined using the registering module 141 of the image registration unit 14, and each of the vectors 643 originates from the first reference point 642 and terminates at a corresponding one of the sample points 641 obtained in step 206. The R-table is built based upon the vectors 643 via the registering module 141, and contains x-axis and y-axis vector components and magnitudes of the vectors 643 as in Table 1.

TABLE 1
The R-Table

| | x-axis | y-axis | |
|---|---|---|---|
| | vector | vector | Magnitude |
| Vector [symbol] | component | component | [symbol] |
| i = 1 | [symbol] | [symbol] | γ₁ |
| i = 2 | [symbol] | [symbol] | γ₂ |
| . | . | . | . |
| . | . | . | . |
| . | . | . | . |
| i = n | [symbol] | [symbol] | γₙ |

Subsequently, an accumulator array H is built by mapping the R-table into corresponding points 651 on the reconstructed portal contour 65 to obtain the second reference point 652 for the reconstructed portal contour 65 corresponding to the first reference point 642. In particular, the registering module 141 shifts all the vectors 643 to the corresponding points 651 as their originating points to define a set of inverse vectors. The accumulator array H is built based upon the inverse vectors, and is composed of elements p(x,y), defined as p(x,y)=p(x,y)+1, if p(x,y) is in a path of the inverse vectors, and otherwise p(x,y)=p(x,y)+0. The second reference point 652 is a point intersected by the inverse vectors with a maximum number of times, i.e., the second reference point 652 can be obtained based upon the equation, R′=Max{∪ p(x,y)}.

Step 209 is to perform image registration using the registering module 141 based upon the first and second reference points 642, 652 of the reconstructed simulation and portal contours 64, 65 to thereby obtain a registered image output. In step 210, image fusion is performed by the image fusing module 142 of the image registration unit 14 based upon the registered image output.

After fusing the registered image output, the user interface 11 allows the user to select isocenters for both of the reconstructed simulation and portal contours. A position error of the isocenters can then be calculated via the portal/non-portal image registration system 1, such that information about the position error can be subsequently provided to a radiotherapist.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A portal/non-portal image registration system for registering portal and non-portal images, comprising:
a user interface operable for selecting a pair of points on the non-portal image and a pair of corresponding points on the portal image;
an image preprocessing unit that is operable, with reference to the points selected for the portal and non-portal images through said user interface, so as to adjust orientations of the portal and non-portal images to minimize an orientation difference therebetween, and to adjust scales of the portal and non-portal images to minimize a scale difference therebetween, thereby obtaining preprocessed portal and non-portal images;
a contour detecting unit operable so as to reconstruct contours of the preprocessed portal and non-portal images from said image preprocessing unit, thereby obtaining reconstructed portal and non-portal contours; and
an image registration unit including a registering module operable so as to conduct image registration based upon feature information of the reconstructed portal and non-portal contours using Generalized Hough Transform, thereby obtaining a registered image output.

2. The portal/non-portal image registration system as claimed in claim 1, wherein said user interface is further operable for selecting a region of interest (ROI) from each of the portal and non-portal images after the orientations and scales of the portal and non-portal images are adjusted by said image preprocessing unit,
said image preprocessing unit is further operable so as to process the ROIs of the portal and non-portal images to obtain the preprocessed portal and non-portal images, and
the reconstructed portal and non-portal contours obtained from said contour detecting unit correspond respectively to the ROIs of the portal and non-portal images.

3. The portal/non-portal image registration system as claimed in claim 2, wherein said contour detecting unit includes an initial contour detecting module operable so as to obtain sample points on an initial contour for each of the preprocessed portal and non-portal images, and a contour-reconstructing module operable so as to obtain the reconstructed portal and non-portal contours from the sample points obtained by said initial contour detecting module.

4. The portal/non-portal image registration system as claimed in claim 3, wherein said user interface is further operable so as to remove unwanted portions of the initial contours for the preprocessed portal and non-portal images prior to sampling of the initial contours by said initial contour detecting module to obtain the sample points.

5. The portal/non-portal image registration system as claimed in claim 3, wherein said user interface is further operable so as to select desired portions of the initial contours for the preprocessed portal and non-portal images prior to sampling of the initial contours by said initial contour detecting module to obtain the sample points.

6. The portal/non-portal image registration system as claimed in claim 3, wherein said contour-reconstructing module is operable so as to obtain the reconstructed portal and non-portal contours from the sample points obtained by said initial contour detecting module using a cubic spline function.

7. The portal/non-portal image registration system as claimed in claim 3, wherein said initial contour detecting module includes an initial contour detecting unit operable so as to detect the initial contours for the preprocessed portal and non-portal images using a modified Otsu's Method, and a sampling unit operable so as to obtain the sample points on the initial contours.

8. The portal/non-portal image registration system as claimed in claim 2, wherein said image preprocessing unit is further operable so as to perform contrast enhancement upon the ROIs of the portal and non-portal images.

9. The portal/non-portal image registration system as claimed in claim 8, wherein said image preprocessing unit is further operable so as to perform noise-removal processing after contrast enhancement to obtain the preprocessed portal and non-portal images.

10. The portal/non-portal image registration system as claimed in claim 1, wherein said image registration unit further includes an image fusing module for fusing the registered image output from said registering module.

11. A portal/non-portal image registration method for registering portal and non-portal images, comprising the following computer-implemented steps:
a) enabling selection of a pair of points on the non-portal image and a pair of corresponding points on the portal image through a user interface;
b) performing image preprocessing with reference to the points selected for the portal and non-portal images so as to obtain preprocessed portal and non-portal images, the image preprocessing including adjusting orientations of the portal and non-portal images to minimize an orientation difference therebetween, and adjusting scales of the portal and non-portal images to minimize a scale difference therebetween;
c) reconstructing contours of the preprocessed portal and non-portal images to obtain reconstructed portal and non-portal contours; and
d) performing image registration based upon feature information of the reconstructed portal and non-portal contours using Generalized Hough Transform, thereby obtaining a registered image output.

12. The portal/non-portal image registration method as claimed in claim 11, wherein:
in step b), selection of a region of interest (ROI) from each of the portal and non-portal images through the user interface is further enabled after the orientations and scales of the portal and non-portal images are adjusted, followed by processing the ROIs of the portal and non-portal images to obtain the preprocessed portal and non-portal images; and
the reconstructed portal and non-portal contours obtained in step c) correspond respectively to the ROIs of the portal and non-portal images.

13. The portal/non-portal image registration method as claimed in claim 12, wherein step c) includes the following computer-implemented sub-steps:
c1) obtaining sample points on an initial contour for each of the preprocessed portal and non-portal images, the initial contour being obtained using a modified Otsu's Method; and
c2) obtaining the reconstructed portal and non-portal contours from the sample points obtained in sub-step c1).

14. The portal/non-portal image registration method as claimed in claim 13, wherein sub-step cl) includes the following computer-implemented sub-steps:
c11) dividing each of the preprocessed portal and non-portal images using a set of lines that intersect orthogonally and that are evenly distributed;
c12) replacing pixel values on the lines by mean values of neighboring pixels;
c13) calculating a gradient of each pixel on the lines;
c14) constructing the initial contour for each of the preprocessed portal and non-portal images based upon the gradients of the pixels on the lines; and
c15) for each of the initial contours, calculating a centroid thereof, and obtaining the sample points at intersections of the initial contour with equiangularly spaced apart radial lines that radiate from the centroid.

15. The portal/non-portal image registration method as claimed in claim 14, wherein:
in sub-step c12), each of the mean values is calculated based upon the equation
$$\overline{I} ( x , y ) = \frac{1}{9} {\sum }_{i = - 1}^{1} {\sum }_{j = - 1}^{1} I ( x + i , y + j ) ,$$
where (x,y) are pixel coordinates, and I is the pixel value;
in sub-step c13), the gradient of each pixel is calculated based upon the equation set
∇g(x,y)=Ī(x,y+1)−Ī(x,y) for vertical lines
∇g(x,y)=Ī(x+1,y)−Ī(x,y) for horizontal lines;
the sub-step cl) further including, prior to sub-step c14), determining an optimal set of threshold values for each of the preprocessed portal and non-portal images based upon the equation
{k₁*,k₂*}∈{Īₘ|Īₘ=medium[Ī(x,y),Ī(∇gₜ(x,y))]};
where ∇gₜ(x,y) is the t^{th} one of the five highest ∇g(x,y) of each line, and Īₘ is a median pixel value from the five highest ∇g(x,y) and the mean value Ī(x,y) of each line; and
in sub-step c14), the initial contour is constructed for each of the preprocessed portal and non-portal images with reference to the optimal set of threshold values.

16. The portal/non-portal image registration method as claimed in claim 14, wherein unwanted portions of the initial contour of each of the preprocessed portal and non-portal images are removed through the user interface prior to the sub-step c15).

17. The portal/non-portal image registration method as claimed in claim 13, wherein the reconstructed portal and non-portal contours are obtained in sub-step c2) using a cubic spline function.

18. The portal/non-portal image registration method as claimed in claim 13, wherein step d) includes the following computer-implemented sub-steps:
d1) defining a first reference point for the reconstructed non-portal contour;
d2) defining a set of vectors, each originating from the first reference point and terminating at a corresponding one of the sample points obtained in sub-step c1);
d3) building an R-table containing x-axis and y-axis vector components and magnitudes of the vectors defined in sub-step d2);
d4) mapping the R-table into corresponding points on the reconstructed portal contour to obtain a second reference point for the reconstructed portal contour corresponding to the first reference point; and
d5)obtaining the registered image output from the reconstructed portal and non-portal contours with reference to the first and second reference points.

19. The portal/non-portal image registration method as claimed in claim 12, wherein, in step b), the image preprocessing further includes contrast enhancement upon the ROIs of the portal and non-portal images, followed by noise-removal processing to obtain the preprocessed portal and non-portal images.

20. The portal/non-portal image registration method as claimed in claim 11, further comprising the computer-implemented step of fusing the registered image output.
